(19) United States
(12) Patent Application Publication
(10) Pub. No.: US 2008/0218056 A1
(43) Pub. Date: Sep. 11, 2008

(54) STRUCTURE OF A FLUORESCENT LAMP SET

(76) Inventor: Liao Chen Hen, Shengang Township (TW)

Correspondence Address: Lowe Hauptman Berner LLP, Suite 300, 1700 Diagnal Road, Alexandria, VA, 22314, US

(21) Appl. No.: 11/682,380

(22) Filed: Mar. 6, 2007

(51) Int. Cl. H01J 63/04

(52) U.S. Cl. 313/493

(57) ABSTRACT

An improved structure of a fluorescent lamp set comprises an outer tube, a fluorescent tube, and a connector. Said fluorescent tube and connector are provided in the interior of said outer tube. The connector is fixed on the surface of said fluorescent tube. Two ends of the outer tube are connected to each seal cover respectively. The internal parts of said seal covers are provided with pins for electrically connecting the fluorescent tube and connector. Said pins are electrically connected to the outer plug assembly.

### BACKGROUND OF THE INVENTION

1. Field of the Invention

The present invention relates to an improved structure of a fluorescent lamp set, particularly to an energy saving lamp structure wherein an outer tube is provided onto the exterior of a fluorescent tube, the two ends of said outer tube are connected to one end of a seal cover respectively, and another end of said seal cover is connected to outer plug assemblies, by which the fluorescent tube or internal parts can be replaced easily at any time.

2. Description of the Prior Art

In a conventional fluorescent lamp, a fluorescent tube is mounted on the holder with a rectifier and starter. Such fluorescent lamp consumes more power, creates a loud noise, and requires high installation and maintenance costs.

Generally, fluorescent lamps can be divided into ordinary fluorescent lamps and energy saving lamps. The two ends of an ordinary fluorescent lamp are provided with electrodes having two or three circles of tungsten filaments. Radioactive materials are applied onto the tungsten filaments, and a suitable amount of mercury is provided in a fluorescent tube and argon (Ar) is filled. The internal wall of said tube is applied with fluorescent materials. When the power is inputted, the current flows through electrodes and the temperature of tungsten filaments increases. Meanwhile, the temperature of radioactive materials also increases, and a large amount of thermal electrons are released, which are pressurized between the two thermal electrons from negative to positive. As a result, the current in the fluorescent tube flows and hits mercury atoms in the tube, and then generates energy to irradiate ultraviolet (UV) rays. After irradiating the fluorescent materials of the glass tube wall by the UV rays, the UV rays can absorb visible lights and ultimately make the fluorescent tube lighted up.

Different from an ordinary fluorescent lamp, the tube wall of an energy saving lamp is applied with rare earth-based phosphors producing three primary colors—blue, green, and red. The three colors, or three narrow spectrums, can be best identified by human naked eyes, so that the higher luminescence efficiency and stronger brightness can be achieved.

A conventional fluorescent lamp, as shown in FIG. 1, comprises a fluorescent tube 11, electronic ballast 12, a starter 13, and a lamp holder 14 for mounting the components mentioned above.

However, the replacement of electronic ballast in a conventional fluorescent lamp is heavy and complicated. Also, the fluorescent tube can not be used anymore when a starter on lamp holder is broken. In addition, the fluorescent tube can not be protected well.

Accordingly, the present invention has been made to solve the above-mentioned problems occurring in the prior art.

### SUMMARY OF THE INVENTION

Accordingly, the major purpose of the present invention is to provide an improved structure of a fluorescent lamp set, wherein an outer tube is provided in the exterior of a fluorescent tube, and a seal cover is provided onto the two ends of said outer tube, so that the fluorescent tube can be protected well and the internal parts in the outer tube can be replaced easily.

Another purpose of the present invention is to provide an improved structure of a fluorescent lamp set by which the lamp parts can be easily replaced by individual users instead of water and electrical technicians. Such lamp set with environmental protection and energy saving features can be available to all.

Another purpose of the present invention is to provide an improved structure of a fluorescent lamp set. With the easy to take apart or replace structure, the manufacture costs can be reduced.

The detailed application principle, structure, function, and effects of the present invention will be more apparent from the following descriptions taken in conjunction with the accompanying drawings.

### BRIEF DESCRIPTION OF THE DRAWINGS

FIG. 1 is a conventional view of the fluorescent lamp set.

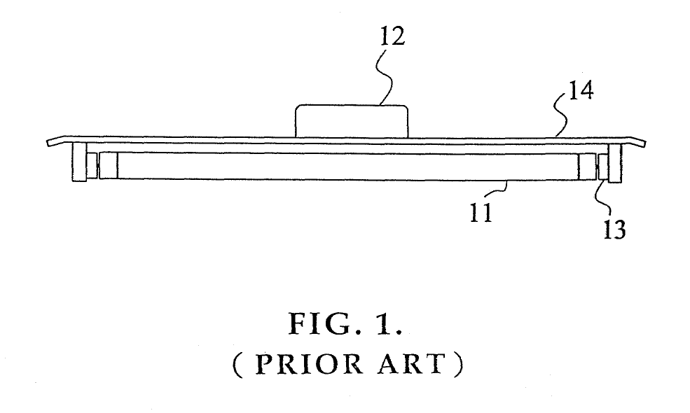

FIG. 2 is an assembly view of the present invention.

FIG. 3 is a three-dimensional exploded view of the present invention.

FIG. 4 is a sectional assembly view of the present invention.

FIG. 5 is a partially enlarged view of the FIG. 4.

FIG. 6 is a perspective drawing of the outer plug assemblies in the present invention.

FIG. 7 is a circuit diagram of the present invention.

### DETAILED DESCRIPTION OF THE PREFERRED EMBODIMENTS

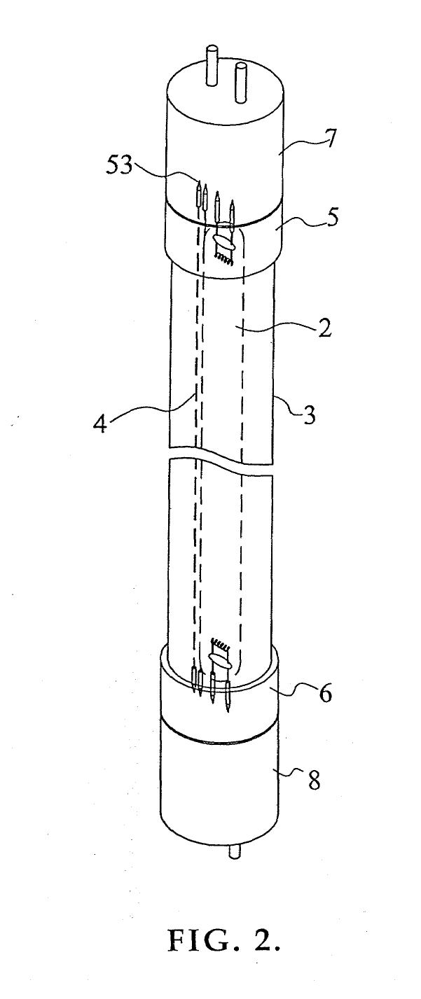

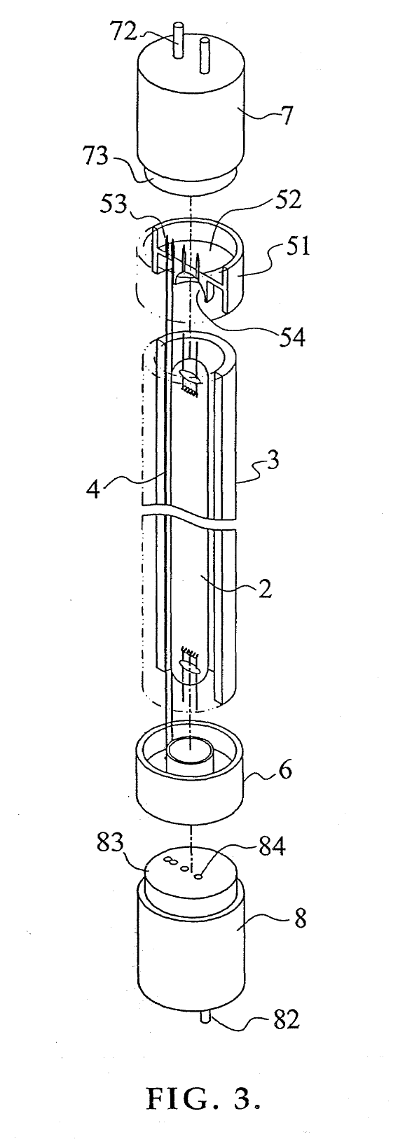

Referring to FIGS. 2 and 3, the improved structure of a fluorescent lamp set in the present invention comprises a fluorescent tube 2 and an outer tube 3, wherein said fluorescent tube 2 is provided throughout the interior of said outer tube 3. Said outer tube 3 is made of transparent materials (i.e. glass, transparent plastic). The connector 4 which is fixed on the surface of said fluorescent tube 2 is provided between the interior of outer tube 3 and fluorescent tube 2. Also, two ends of said outer tube 3 are provided with seal covers 5 and 6 respectively. Another end of said seal cover 5 and 6 is connected to the outer plug assembly 7 and 8 respectively.

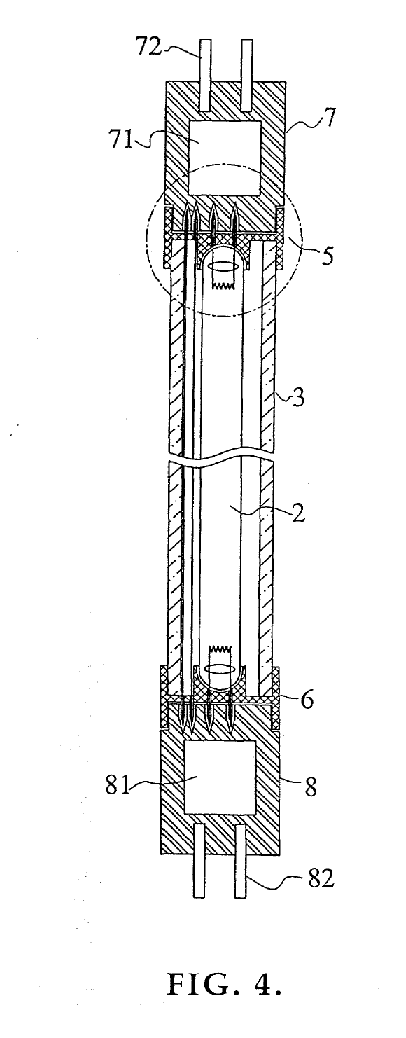

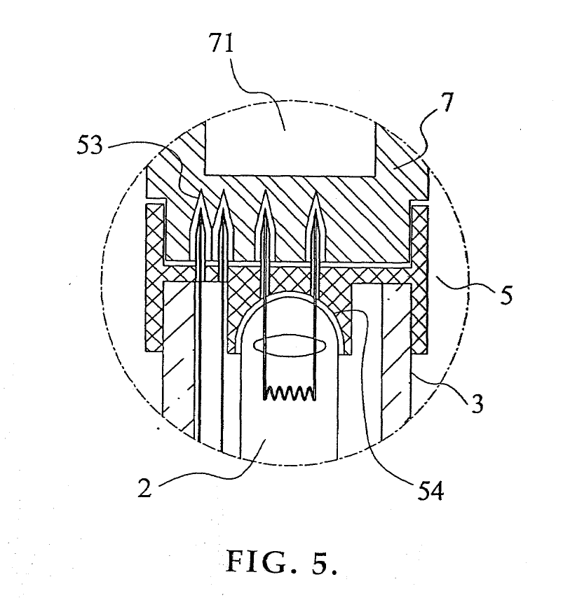

Referring to FIGS. 4 and 5, as to seal covers 5 and 6, a partition 52 is disposed in the center of a circular means 51, the upper surface of partition 52 is provided with a plurality of pins 53 which are perpendicular to the pins 53. Each of pins 53 is connected to the connector 4, so that a two-way loop is formed in the pins 53 in the two ends of a connector 4; the lower surface of said partition 52 is provided with a downward extended slipcover 54. The caliber of said slipcover 54 can be exactly fitted in with the head of fluorescent tube 2, so that the fluorescent tube 2 can be electrically connected.

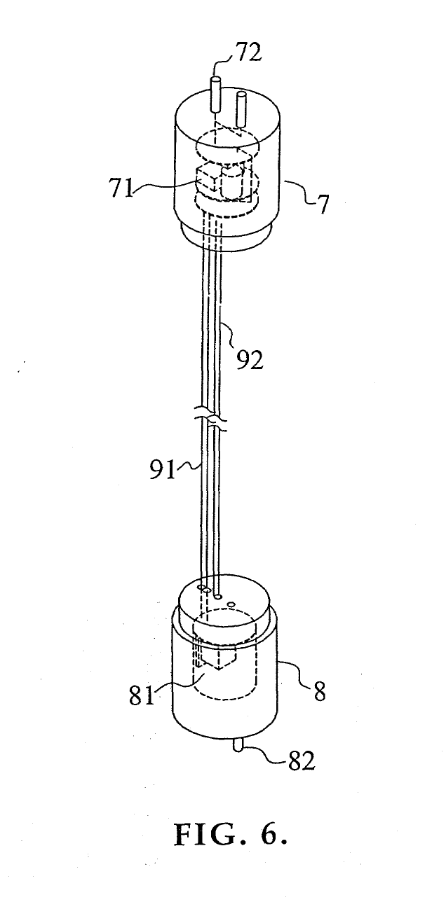

Referring to FIG. 6, the interior of said outer plug assembly 7 is provided with a circuit control device 71, and the interior of said outer plug assembly 8 is provided with an inductor 81. The outside of said outer plug assemblies 7 and 8 are provided with outer pins 72 and 82. Protruding parts 73, 83 are formed and extended downward in the bottom of said outer plug assemblies. Also, a plurality of jacks 84 are formed on the surface of protruding parts 73 and 83 corresponding to the pins 53 of seal covers 5 and 6, through which the seal covers 5 and 6 can be inserted into jacks 84 through pins 53, and thus can be electrically connected to the outer plug assemblies 7 and 8.

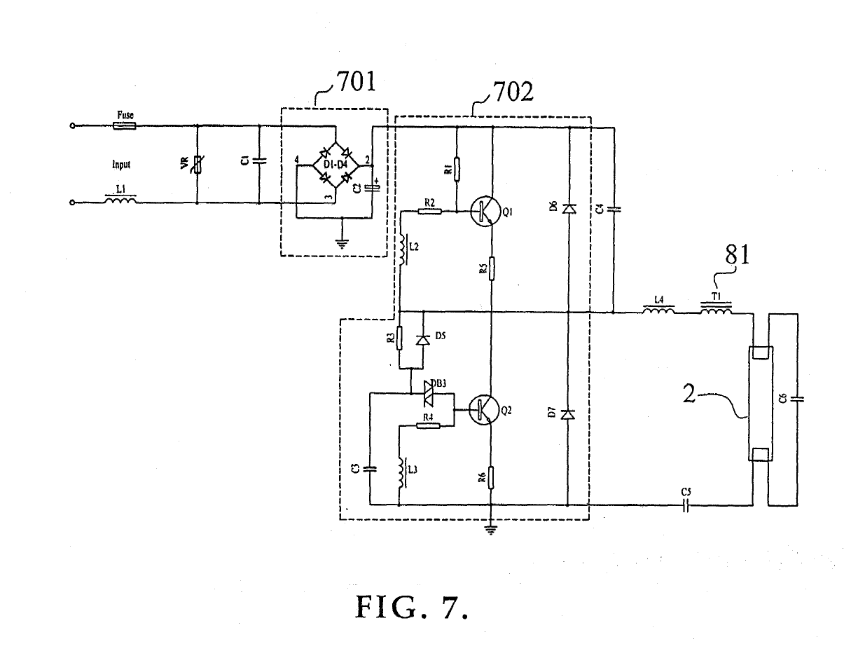

Referring to FIG. 7, the circuit control device 71 in the interior of said outer plug assembly 7, and the inductor 81 in the interior of said outer plug assembly 8, is electrically connected to each other through a two-way loop 91. The pins 72 of outer plug assembly 7 are electrically connected to a circuit control device 71, while the pins 82 of said outer plug assembly 8 are electrically connected to a circuit control device 71 through an interchange wire 92. As shown in the figures, said circuit control device 71 includes a rectifier 701 and a high frequency inverter 702. The input of said rectifier 701 is connected to external power, and transforms the normal home use alternating current (AC) to the required direct current (DC). Also, the output of said rectifier 701 is electrically connected to the high frequency inverter 702 which inversely transforms the direct current (DC) to a high frequency alternating current and provides power required by the fluorescent tube 1.

In the practical use, external power (typical home use alternating current (AC)) can be inputted into the interior of outer tube 3 through the pins 72, 82 of outer plug assemblies 7 and 8. The inputted power in the outer plug assembly 8 is connected to the input of said circuit control device 71 through an interchange wire 92, while another input of said circuit control device 71 is directly connected to the pins 71 of said outer plug assembly 7. Since the pins 72 and 82 of outer plug assemblies 7 and 8 are connected to each other, the power can be conducted as long as a pin 72 (or 82) is connected to power.

Preferably, said seal covers 5 and 6 are made of resilient plastic or rubber materials so that the seal covers can be tied in with the outer tube 3 or outer plug assemblies 7 and 8 and replaced easily.

In the improved structure of a fluorescent lamp set in the present invention, owing to the lamp set is the non-seal type, when a fluorescent tube is damaged, the seal covers 5 and 6 can be apart from the outer tube 3 directly for replacement of a fluorescent tube; moreover, through the non-seal structure, the inductive components and circuit board can be replaced easily. Also, since it is not required to heat the filaments, the fluorescent tube can be lighted up directly with high frequency, and the life time of the fluorescent tube can be increased.

As described above, the improved structure of a fluorescent lamp set is formed as a non-seal type, wherein the internal fluorescent tube can be well protected, while the internal fluorescent tube or outer plug assemblies can be replaced easily when they are damaged. Also, the present invention has not yet been made public, which is consistent with relevant Patent Law.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An improved structure of a fluorescent lamp set comprising:
a fluorescent tube; and
an outer tube,
wherein said fluorescent tube is provided throughout the interior of said outer tube which is made of transparent materials; a connector is provided between the interior of outer tube and said fluorescent tube; two ends of said outer tube are provided with plug assemblies for connecting to the power source; a seal cover is provided between said outer tube and plug assemblies.

2. The improved structure of a fluorescent lamp set as claimed in claim 1, wherein the interior of said seal cover is provided with pins for electrically connecting said fluorescent tube and connector.

3. The improved structure of a fluorescent lamp set as claimed in claim 1, wherein the interior of said seal cover is provided with a slipcover which is tied in with said fluorescent tube.

4. The improved structure of a fluorescent lamp set as claimed in claim 1, wherein said seal cover is made of resilient plastic or rubber materials.

5. The improved structure of a fluorescent lamp set as claimed in claim 1, wherein the interior of one outer plug assembly is provided with a circuit control device which includes a rectifier and a high frequency inverter; the interior of another outer plug assembly is provided with an inductor; a two-way loop is provided to electrically connect said circuit control device and inductor.

6. The improved structure of a fluorescent lamp set as claimed in claim 1, wherein said outer tube can be made of glass or transparent plastic materials.
